(19) United States
(12) Patent Application Publication
(10) Pub. No.: US 2025/0305870 A1
(43) Pub. Date: Oct. 2, 2025

(54) ACOUSTIC WAVE RECEIVING APPARATUS

(71) Applicant: INDUSTRIAL TECHNOLOGY RESEARCH INSTITUTE, Hsinchu (TW)

(72) Inventors: Chin-Jou KUO, Tainan City (TW); Chih-Yuan CHEN, Tainan City (TW); Bor-Shiun LEE, New Taipei City (TW); Chung-Yuan SU, Tainan City (TW)

(73) Assignee: INDUSTRIAL TECHNOLOGY RESEARCH INSTITUTE, Hsinchu (TW)

(21) Appl. No.: 18/986,321

(22) Filed: Dec. 18, 2024

Related U.S. Application Data
(60) Provisional application No. 63/569,809, filed on Mar. 26, 2024.

(30) Foreign Application Priority Data
Oct. 30, 2024 (TW) 113141536

(51) Int. Cl. G01H 3/12; G01M 3/24

(52) U.S. Cl. CPC G01H 3/12; G01M 3/24

(57) ABSTRACT

An acoustic wave receiving apparatus is provided. The acoustic wave receiving apparatus includes an acoustic wave receiver and a sound collecting structure. The acoustic wave receiver includes an acoustic sensing element, a circuit module and a housing, wherein the acoustic sensing element is disposed within the housing, the acoustic sensing element is coupled to the circuit module, and the housing has a housing opening. The sound collecting structure is in fluid communication with the acoustic wave receiver, wherein the sound collecting structure includes a first cavity and a second cavity, the first cavity is in fluid communication with the housing opening, the second cavity includes an inner opening and an outer opening, and the inner opening is in fluid communication with the first cavity.

### CROSS REFERENCE TO RELATED APPLICATIONS

This application claims the benefit of U.S. Provisional Application No. 63/569,809, filed Mar. 26, 2024, the entirety of which is incorporated by reference herein.

This Application claims priority of Taiwan Patent Application No. 113141536, filed on Oct. 30, 2024, the entirety of which is incorporated by reference herein.

### BACKGROUND OF THE INVENTION

### Field of the Invention

The present invention relates to an acoustic wave receiving apparatus, and, in particular, it relates to an acoustic wave receiving apparatus with improved detection effects for acoustic signals within specific frequency bands.

### Description of the Related Art

In modern industrial and domestic settings, pressure vessels such as cylinders, storage tanks, and pipelines are widely utilized to store and transport compressed gases. Their applications are very common. However, for various reasons, these pressure vessels are prone to leaks, leading to gas leakage. Such leakage not only causes energy waste but, in the case of certain gases, also results in air pollution. Therefore, accurately detecting and pinpointing the location of leaks is critically important.

Conventionally, acoustic wave receiving apparatuses are used for detecting gas leaks. However, conventional acoustic wave receiving apparatuses have a limited detection range and high error rates, reducing their practicality and reliability.

### BRIEF SUMMARY OF THE INVENTION

An acoustic wave receiving apparatus is provided. The acoustic wave receiving apparatus includes an acoustic wave receiver and a sound collecting structure. The acoustic wave receiver includes an acoustic sensing element, a circuit module and a housing, wherein the acoustic sensing element is disposed within the housing, the acoustic sensing element is coupled to the circuit module, and the housing has a housing opening. The sound collecting structure is in fluid communication with the acoustic wave receiver, wherein the sound collecting structure comprises a first cavity and a second cavity, the first cavity is in fluid communication with the housing opening, the second cavity comprises an inner opening and an outer opening, and the inner opening is in fluid communication with the first cavity.

In one embodiment, the first cavity is located between the second cavity and the housing.

In one embodiment, the inner opening and the outer opening of the second cavity are the same size.

In one embodiment, the first cavity has a first cavity volume, and the second cavity has a second cavity volume, and the ratio of the second cavity volume to the first cavity volume is between 1 and 0.1.

In one embodiment, the first cavity has a maximum cross-sectional width between 3 mm and 10 mm, and the second cavity has a maximum cross-sectional width between 2 mm and 5 mm.

In one embodiment, the first cavity has a depth between 1 mm and 3 mm, and the second cavity has a depth between 1 mm and 3 mm.

In one embodiment, the acoustic wave receiver is located outside of the first cavity.

In one embodiment, the sound collecting structure further comprises an external cavity in fluid communication with the external environment, and the outer opening of the second cavity is in fluid communication with the external cavity.

In one embodiment, the first cavity is located between the second cavity and the housing, and the second cavity is located between the first cavity and the external cavity.

In one embodiment, the first cavity has a first cavity volume, the second cavity has a second cavity volume, the external cavity has an external cavity volume, the ratio of the second cavity volume to the first cavity volume is between 1 and 0.1, and the external cavity volume is greater than the first cavity volume.

In one embodiment, the first cavity has a first cavity diameter, the second cavity has a second cavity diameter, the external cavity has an external cavity diameter, the second cavity diameter is less than or equal to the first cavity diameter, and the second cavity diameter is less than the external cavity diameter.

In one embodiment, the external cavity expands outward toward the external environment.

In another embodiment, an acoustic wave receiving apparatus is provided. The acoustic wave receiving apparatus includes a first acoustic wave receiver, a second acoustic wave receiver and a sound collecting structure. The first acoustic wave receiver includes a first acoustic sensing element, a first circuit module and a first housing, wherein the first acoustic sensing element is disposed in the first housing and coupled to the first circuit module, and the first housing has a first housing opening. The second acoustic wave receiver includes a second acoustic sensing element, a second circuit module and a second housing, wherein the second acoustic sensing element is disposed in the second housing and coupled to the second circuit module, and the second housing has a second housing opening. The sound collecting structure is in fluid communication with the first and second acoustic wave receivers, wherein the sound collecting structure comprises a first cavity, a second cavity, a third cavity, and a fourth cavity, the first cavity is in fluid communication with the second cavity, the third cavity is in fluid communication with the fourth cavity, the first housing opening is in fluid communication with both the first and second cavities, and the second housing opening is in fluid communication with both the third and fourth cavities.

In one embodiment, the first cavity is located between the second cavity and the first housing opening, and the third cavity is located between the fourth cavity and the second housing opening.

In one embodiment, the first cavity has a first cavity volume, the second cavity has a second cavity volume, the third cavity has a third cavity volume, the fourth cavity has a fourth cavity volume, the ratio of the second cavity volume to the first cavity volume is between 1 and 0.1, and the ratio of the fourth cavity volume to the third cavity volume is also between 1 and 0.1, with the two ratios differing.

In one embodiment, the sound collecting structure further comprises an external cavity, the second cavity is located between the first cavity and the external cavity, and the fourth cavity is located between the third cavity and the external cavity, and the external cavity is in fluid communication with the external environment.

In one embodiment, the external cavity has an external cavity volume, the external cavity volume is greater than the first cavity volume, and the external cavity volume is greater than the third cavity volume.

In one embodiment, the first and second cavities are configured to enhance a first acoustic signal, the third and fourth cavities are configured to enhance a second acoustic signal, the first acoustic signal has a first frequency, the second acoustic signal has a second frequency, and the first frequency is lower than the second frequency.

In one embodiment, the first acoustic signal has a first wavelength, and a sensing distance is formed between the first and second acoustic sensing elements, and the sensing distance is greater than half the first wavelength.

In one embodiment, the acoustic wave receiving apparatus further comprises a processor, and the processor is coupled to both the first circuit module and the second circuit module.

The acoustic wave receiving apparatus according to the embodiments of the invention can detect acoustic signals within specific frequency bands. When the acoustic wave receiving apparatus is applied to detect gas leaks, the detection sensitivity and accuracy can be effectively improved. Additionally, with an appropriately designed external cavity, the detection bandwidth and distance can be further increased. Thus, the acoustic wave receiving apparatus of the embodiment of the invention has excellent practicality and reliability.

### BRIEF DESCRIPTION OF THE DRAWINGS

The present invention can be more fully understood by reading the subsequent detailed description and examples with references made to the accompanying drawings, wherein:

FIG. 1 shows an acoustic wave receiving apparatus of a first embodiment of the invention;

FIG. 2 shows an acoustic wave receiving apparatus of a second embodiment of the invention;

FIG. 3 shows an acoustic wave receiving apparatus of a third embodiment of the invention;

FIG. 4A shows an acoustic wave receiving apparatus of a fourth embodiment of the invention;

FIG. 4B is a block diagram of the acoustic wave receiving apparatus of the fourth embodiment of the invention; and

FIG. 5 shows the sound reception performance of the acoustic wave receiving apparatus of the embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

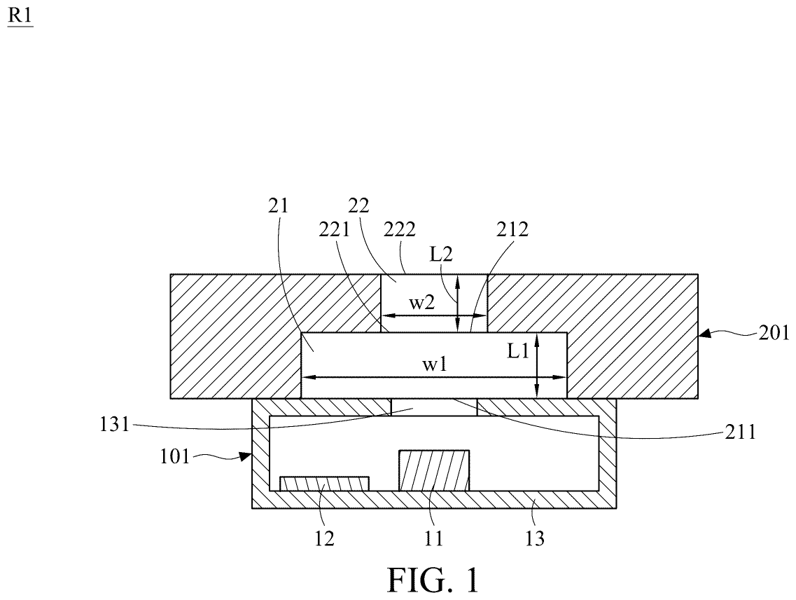

FIG. 1 shows an acoustic wave receiving apparatus of a first embodiment of the invention. With reference to FIG. 1, the acoustic wave receiving apparatus R1 of the first embodiment of the invention includes an acoustic wave receiver 101 and a sound collecting structure 201. The acoustic wave receiver 101 includes an acoustic sensing element 11, a circuit module 12 and a housing 13. The acoustic sensing element 11 is disposed within the housing 13. The acoustic sensing element 11 is coupled to the circuit module 12. The housing 13 has a housing opening 131. The sound collecting structure 201 is disposed outside of the acoustic wave receiver 101, and is in fluid communication with the acoustic wave receiver 101. The sound collecting structure 201 comprises a first cavity 21 and a second cavity 22. The first cavity 21 is in fluid communication with the housing opening 131. The first cavity 21 is located between the second cavity 22 and the housing opening 131.

With reference to FIG. 1, in one embodiment, the second cavity 22 comprises a second inner opening 221 and a second outer opening 222. The second inner opening 221 is in fluid communication with the first cavity 21. The size of the second inner opening 221 is the same with the second outer opening 222.

With reference to FIG. 1, in one embodiment, the first cavity 21 comprises a first inner opening 211 and a first outer opening 212. The first cavity 22 is in fluid communication with the second cavity 21 via the first outer opening 212 and the second inner opening 221. In this embodiment, the second outer opening 222 is in fluid communication with the external environment.

With reference to FIG. 1, in one embodiment, the first cavity 21 has a first cavity volume, and the second cavity 22 has a second cavity volume, and the ratio of the second cavity volume to the first cavity volume is between 1 and 0.1.

With reference to FIG. 1, in one embodiment, the first cavity 21 has a maximum cross-sectional width w1 between 3 mm and 10 mm, and the second cavity 22 has a maximum cross-sectional width w2 between 2 mm and 5 mm. The first cavity 21 and the second cavity 22 can be tube-shaped or in other shape. The disclosure is not meant to restrict the invention.

With reference to FIG. 1, in one embodiment, the first cavity 21 has a depth L1 between 1 mm and 3 mm, and the second cavity 22 has a depth L2 between 1 mm and 3 mm.

With reference to FIG. 1, in one embodiment, the acoustic wave receiver 101 is located outside of the first cavity 21.

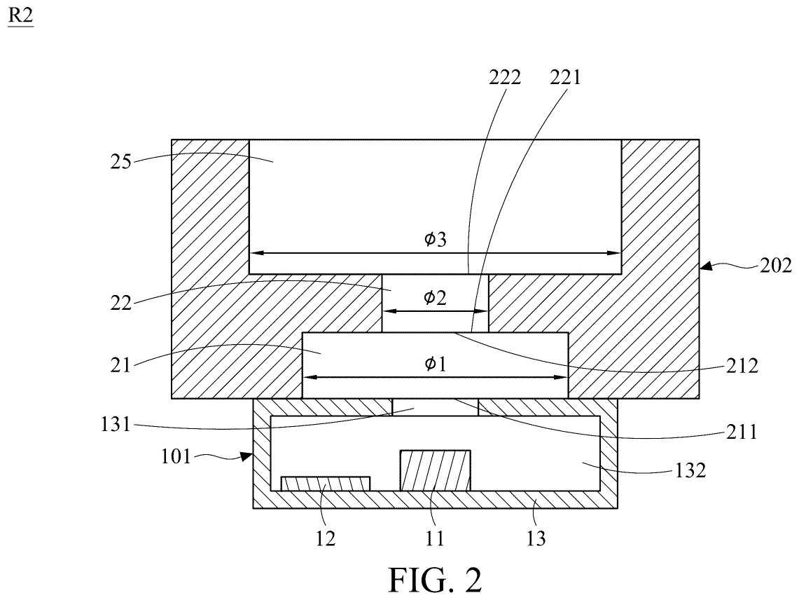

FIG. 2 shows an acoustic wave receiving apparatus of a second embodiment of the invention. With reference to FIG. 2, the acoustic wave receiving apparatus R2 of the first embodiment of the invention includes an acoustic wave receiver 101 and a sound collecting structure 202. The acoustic wave receiver 101 includes an acoustic sensing element 11, a circuit module 12 and a housing 13. The acoustic sensing element 11 and the circuit module 12 are disposed within a sensing space 132 within the housing 13. The acoustic sensing element 11 is coupled to the circuit module 12. The housing 13 has a housing opening 131. The housing opening 131 is in fluid communication with the sensing space 132. The sound collecting structure 202 is disposed outside of the acoustic wave receiver 101, and is in fluid communication with the acoustic wave receiver 101. The sound collecting structure 202 comprises a first cavity 21, a second cavity 22 and an external cavity 25. The first cavity 21 is in fluid communication with the housing opening 131 and the second cavity 22. The first cavity 21 is located between the second cavity 22 and the housing opening 131. The second cavity 22 is located between the first cavity 21 and the external cavity 25. The external cavity 25 is in fluid communication with the external environment.

With reference to FIG. 2, in one embodiment, the first cavity 21 has a first cavity volume. The second cavity 22 has a second cavity volume. The external cavity 25 has an external cavity volume. The ratio of the second cavity volume to the first cavity volume is between 1 and 0.1, and the external cavity volume is greater than the first cavity volume.

With reference to FIG. 2, in one embodiment, the first cavity 21 has a first cavity diameter φ1, the second cavity has a second cavity diameter φ2, and the external cavity has an external cavity diameter φ3. The second cavity diameter φ2 is less than or equal to the first cavity diameter φ1, and the second cavity diameter φ2 is less than the external cavity diameter φ3.

With reference to FIG. 2, in one embodiment, the second cavity 22 includes a second inner opening 221 and a second outer opening 222. The second inner opening 221 is connected to the first cavity 21. The size of the second inner opening 221 is the same with the size of the second outer opening 222.

With reference to FIG. 2, in one embodiment, the first cavity 21 includes a first inner opening 211 and a first outer opening 212. The first cavity 21 is in fluid communication with the second cavity 22 via the first outer opening 212 and the second inner opening 221. In this embodiment, the second outer opening 222 of the second cavity 22 is in fluid communication with the external environment.

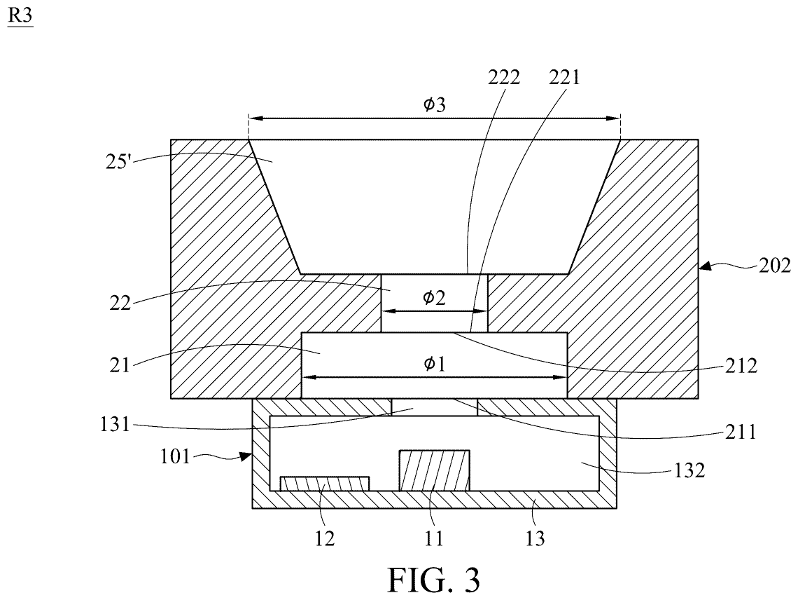

FIG. 3 shows an acoustic wave receiving apparatus of a third embodiment of the invention. With reference to FIG. 3, in another embodiment, the acoustic wave receiving apparatus R3 of the embodiment of the invention has the external cavity 25′ expands outward toward the external environment. In this embodiment, the external cavity 25′ has sound collection effect.

With reference to FIG. 3, in one embodiment, the second cavity 22 includes a second inner opening 221 and a second outer opening 222. The second inner opening 221 is connected to the first cavity 21. The size of the second inner opening 221 is the same with the size of the second outer opening 222.

With reference to FIG. 3, in one embodiment, the first cavity 21 includes a first inner opening 211 and a first outer opening 212. The first cavity 21 is in fluid communication with the second cavity 22 via the first outer opening 212 and the second inner opening 221. In this embodiment, the second outer opening 222 of the second cavity 22 is in fluid communication with the external environment.

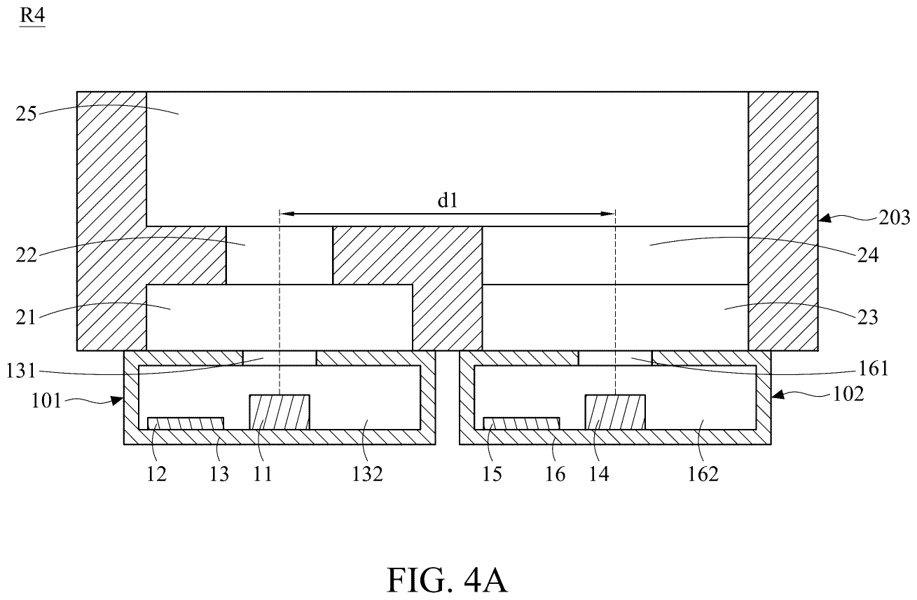

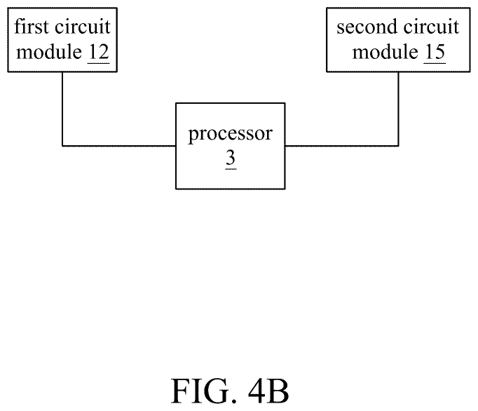

FIG. 4A shows an acoustic wave receiving apparatus of a fourth embodiment of the invention. FIG. 4B is a block diagram of the acoustic wave receiving apparatus of the fourth embodiment of the invention. With reference to FIGS. 4A and 4B, in another embodiment, an acoustic wave receiving apparatus R4 is provided. The acoustic wave receiving apparatus R4 includes a first acoustic wave receiver 101, a second acoustic wave receiver 102 and a sound collecting structure 203. The first acoustic wave receiver 101 includes a first acoustic sensing element 11, a first circuit module 12 and a first housing 13. The first acoustic sensing element 11 and the first circuit module 12 are disposed in a first sensing space 132 of the first housing 13. The first acoustic sensing element 11 is coupled to the first circuit module 12. The first housing 13 has a first housing opening 131 which is in fluid communication with the first sensing space 132. The second acoustic wave receiver 102 includes a second acoustic sensing element 14, a second circuit module 15 and a second housing 16. The second acoustic sensing element 14 and the second circuit module 15 are disposed in a second sensing space 162 of the second housing 16. The second acoustic sensing element 14 is coupled to the second circuit module 15. The second housing 16 has a second housing opening 161 which is in fluid communication with the second sensing space 162. The sound collecting structure 203 is disposed outside of the first acoustic wave receiver 101 and second acoustic wave receiver 102, and is in fluid communication with the first acoustic wave receiver 101 and second acoustic wave receiver 102. The sound collecting structure 203 comprises a first cavity 21, a second cavity 22, a third cavity 23, and a fourth cavity 24. The first cavity 21 is in fluid communication with the second cavity 22. The third cavity 23 is in fluid communication with the fourth cavity 24. The first housing opening 131 is in fluid communication with the first cavity 21. The second housing opening 161 is in fluid communication with the third cavity 23. In one embodiment, the first cavity 21 is located between the second cavity 22 and the first housing opening 131, and the third cavity 23 is located between the fourth cavity 24 and the second housing opening 161.

With reference to FIGS. 4A and 4B, in one embodiment, the first cavity 21 has a first cavity volume, the second cavity 22 has a second cavity volume, the third cavity 23 has a third cavity volume, and the fourth cavity 24 has a fourth cavity volume. The ratio of the second cavity volume to the first cavity volume is between 1 and 0.1, and the ratio of the fourth cavity volume to the third cavity volume is also between 1 and 0.1, with the two ratios differing.

With reference to FIGS. 4A and 4B, in one embodiment, the sound collecting structure 203 further comprises an external cavity 25. The second cavity 22 is located between the first cavity 21 and the external cavity 25. The fourth cavity 24 is located between the third cavity 23 and the external cavity 25. The external cavity 25 is in fluid communication with the external environment.

With reference to FIGS. 4A and 4B, in one embodiment, the external cavity 25 has an external cavity volume. The external cavity volume is greater than the first cavity volume, and the external cavity volume is greater than the third cavity volume.

With reference to FIGS. 4A and 4B, in one embodiment, the first cavity 21 and second cavity 22 are configured to enhance a first acoustic signal. The third cavity 23 and fourth cavity 24 are configured to enhance a second acoustic signal. The first acoustic signal has a first frequency, the second acoustic signal has a second frequency, and the first frequency is lower than the second frequency.

With reference to FIGS. 4A and 4B, in one embodiment, the first acoustic signal has a first wavelength, and a sensing distance dl is formed between the first acoustic sensing element 11 and second acoustic sensing element 14. The sensing distance dl is greater than half the first wavelength. In one embodiment, the sensing distance dl can be 2 mm˜20 mm.

With reference to FIGS. 4A and 4B, in one embodiment, the acoustic wave receiving apparatus further comprises a processor 3. The processor 3 is coupled to both the first circuit module 12 and the second circuit module 15. The processor 3 receives signals from the first circuit module 12 and the second circuit module 15, and analyses and process the received signals.

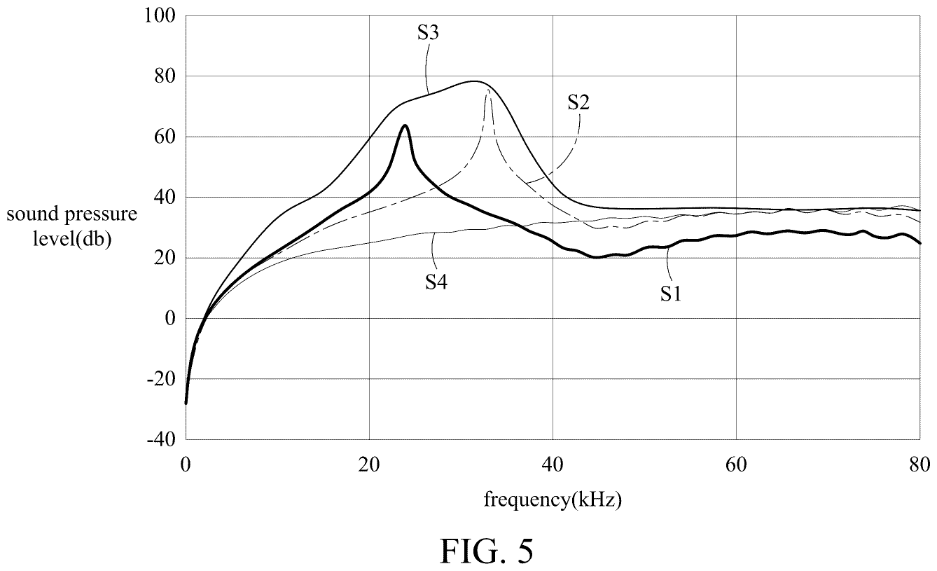

FIG. 5 shows the sound reception performance of the acoustic wave receiving apparatus of the embodiment of the invention. With reference to FIG. 5, the performance of conventional acoustic wave receiving apparatus is represented by line segment S4. When the acoustic wave receiving apparatus of the first embodiment of the invention is utilized, the sound reception performance for specific frequency bands can be enhanced. For instance, if the ratio of the second cavity volume to the first cavity volume is 0.5, the reception performance corresponds to line segment S1. If the ratio is 0.7, the performance corresponds to line segment S2. Further, employing the acoustic wave receiving apparatus of the fourth embodiment of the invention, the bandwidth of the enhanced signal is extended. For example, when the ratio of the second cavity volume to the first cavity volume is 0.5, and the ratio of the fourth cavity volume to the third cavity volume is 0.7, the reception performance corresponds to line segment S3. Moreover, the design of the external cavity allows for additional improvement in detection distance.

The acoustic wave receiving apparatus according to the embodiments of the invention can detect acoustic signals within specific frequency bands. When the acoustic wave receiving apparatus is applied to detect gas leaks, the detection sensitivity and accuracy can be effectively improved. Additionally, with an appropriately designed external cavity, the detection bandwidth and distance can be further increased. Thus, the acoustic wave receiving apparatus of the embodiment of the invention has excellent practicality and reliability.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An acoustic wave receiving apparatus, comprising:
an acoustic wave receiver, comprising an acoustic sensing element, a circuit module and a housing, wherein the acoustic sensing element is disposed within the housing, the acoustic sensing element is coupled to the circuit module, and the housing has a housing opening; and
a sound collecting structure, in fluid communication with the acoustic wave receiver, wherein the sound collecting structure comprises a first cavity and a second cavity, the first cavity is in fluid communication with the housing opening, the second cavity comprises an inner opening and an outer opening, and the inner opening is in fluid communication with the first cavity.

2. The acoustic wave receiving apparatus as claimed in claim 1, wherein the first cavity is located between the second cavity and the housing.

3. The acoustic wave receiving apparatus as claimed in claim 2, wherein the inner opening and the outer opening of the second cavity are the same size.

4. The acoustic wave receiving apparatus as claimed in claim 2, wherein the first cavity has a first cavity volume, and the second cavity has a second cavity volume, and a ratio of the second cavity volume to the first cavity volume is between 1 and 0.1.

5. The acoustic wave receiving apparatus as claimed in claim 2, wherein the first cavity has a maximum cross-sectional width between 3 mm and 10 mm, and the second cavity has a maximum cross-sectional width between 2 mm and 5 mm.

6. The acoustic wave receiving apparatus as claimed in claim 2, wherein the first cavity has a depth between 1 mm and 3 mm, and the second cavity has a depth between 1 mm and 3 mm.

7. The acoustic wave receiving apparatus as claimed in claim 2, wherein the acoustic wave receiver is located outside of the first cavity.

8. The acoustic wave receiving apparatus as claimed in claim 1, wherein the sound collecting structure further comprises an external cavity in fluid communication with an external environment, and the outer opening of the second cavity is in fluid communication with the external cavity.

9. The acoustic wave receiving apparatus as claimed in claim 8, wherein the first cavity is located between the second cavity and the housing, and the second cavity is located between the first cavity and the external cavity.

10. The acoustic wave receiving apparatus as claimed in claim 9, wherein the first cavity has a first cavity volume, the second cavity has a second cavity volume, the external cavity has an external cavity volume, a ratio of the second cavity volume to the first cavity volume is between 1 and 0.1, and the external cavity volume is greater than the first cavity volume.

11. The acoustic wave receiving apparatus as claimed in claim 10, wherein the first cavity has a first cavity diameter, the second cavity has a second cavity diameter, the external cavity has an external cavity diameter, the second cavity diameter is less than or equal to the first cavity diameter, and the second cavity diameter is less than the external cavity diameter.

12. The acoustic wave receiving apparatus as claimed in claim 11, wherein the external cavity expands outward toward the external environment.

13. An acoustic wave receiving apparatus, comprising:
a first acoustic wave receiver, comprising a first acoustic sensing element, a first circuit module and a first housing, wherein the first acoustic sensing element is disposed in the first housing and coupled to the first circuit module, and the first housing has a first housing opening;
a second acoustic wave receiver, comprising a second acoustic sensing element, a second circuit module and a second housing, wherein the second acoustic sensing element is disposed in the second housing and is coupled to the second circuit module, and the second housing has a second housing opening; and
a sound collecting structure, in fluid communication with the first and second acoustic wave receivers, wherein the sound collecting structure comprises a first cavity, a second cavity, a third cavity, and a fourth cavity, wherein the first cavity is in fluid communication with the second cavity, the third cavity is in fluid communication with the fourth cavity, the first housing opening is in fluid communication with both the first and second cavities, and the second housing opening is in fluid communication with both the third and fourth cavities.

14. The acoustic wave receiving apparatus as claimed in claim 13, wherein the first cavity is located between the second cavity and the first housing opening, and the third cavity is located between the fourth cavity and the second housing opening.

15. The acoustic wave receiving apparatus as claimed in claim 14, wherein the first cavity has a first cavity volume, the second cavity has a second cavity volume, the third cavity has a third cavity volume, the fourth cavity has a fourth cavity volume, a ratio of the second cavity volume to the first cavity volume is between 1 and 0.1, and a ratio of the fourth cavity volume to the third cavity volume is also between 1 and 0.1, with the two ratios differing.

16. The acoustic wave receiving apparatus as claimed in claim 15, wherein the sound collecting structure further comprises an external cavity, the second cavity is located between the first cavity and the external cavity, and the fourth cavity is located between the third cavity and the external cavity, and the external cavity is in fluid communication with the external environment.

17. The acoustic wave receiving apparatus as claimed in claim 16, wherein the external cavity has an external cavity volume, the external cavity volume is greater than the first cavity volume, and the external cavity volume is greater than the third cavity volume.

18. The acoustic wave receiving apparatus as claimed in claim 15, wherein the first and second cavities are configured to enhance a first acoustic signal, the third and fourth cavities are configured to enhance a second acoustic signal, the first acoustic signal has a first frequency, the second acoustic signal has a second frequency, and the first frequency is lower than the second frequency.

19. The acoustic wave receiving apparatus as claimed in claim 18, wherein the first acoustic signal has a first wavelength, and a sensing distance is formed between the first and second acoustic sensing elements, and the sensing distance is greater than half the first wavelength.

20. The acoustic wave receiving apparatus as claimed in claim 15, further comprising a processor, and the processor is coupled to both the first circuit module and the second circuit module.
